(19) United States
(12) Patent Application Publication
(10) Pub. No.: US 2017/0016561 A1
(43) Pub. Date: Jan. 19, 2017

(54) METHOD FOR THE PRODUCTION OF A CONVEYING PIPE FOR THE TRANSPORT OF SOLIDS, AND CONVEYING PIPE FOR THE TRANSPORT OF SOLIDS

(71) Applicant: Esser-Werke GmbH & Co. KG, Warstein (DE)

(72) Inventor: Ruediger LUIG, Warstein (DE)

(73) Assignee: Esser-Werke GmbH & Co. KG, Warstein (DE)

(21) Appl. No.: 15/210,168

(22) Filed: Jul. 14, 2016

(30) Foreign Application Priority Data
Jul. 15, 2015 (DE) 102015111455.0

(51) Int. Cl. F16L 23/026; B23K 31/02; B21D 41/02

(52) U.S. Cl. CPC F16L 23/026; B21D 41/02; B23K 31/02; B23K 2201/06

(57) ABSTRACT

A method for the production of a conveying pipe 18, and to a conveying pipe 18, having a circumferential annular bead 13 in the region of an end segment, for thermally decoupling a double-walled pipe body 1 during the creation of the thermal joining seam 17.

### FIELD OF THE INVENTION

The present invention relates to a method for the production of a conveying pipe for the conveying of solids, according to the features in the preamble of claim 1.

The present invention further relates to a conveying pipe for the conveying of solids according to the features in the preamble of claim 17.

### PRIOR ART

In the prior art, the use of pipe conduits for conveying solids is known. For this purpose, different conveying pipes are connected to each other via fittings and pipe bends in order to convey solids—for example slurries, concrete, and even gravel or other solids—using a fluid. The pipes and pipe bends in this case are subjected to high wear during the conveying of solids, such that specially hardened pipes are used. The use of double-walled pipes has been shown as advantageous in the prior art—specifically an inner pipe made of a hardened steel alloy, encased in an outer pipe with rather ductile material properties. Then, to create pipe conduits, these longitudinal pipe bodies are configured on their ends with a pipe collar so that the same can in turn be connected to a fitting or a pipe bend, as well as a further longitudinal conveying pipe. The transition point from the hardened inner pipe of the conveying pipe to the pipe collar, however, is always a potential weak point, which is also subjected to greater wear.

The pipe collar in this case is coupled to the end of the conveying pipe in various ways. By way of example, the pipe collar can be glued, press-fit, bolted, or welded to the end of the conveying pipe.

The problem addressed by the invention is that of providing a method to couple a conveying pipe for the conveying of solids to a pipe collar, wherein the coupling can be made in a reliable production process with high strength, but at the same time requires little production time and is cost-effective.

### BRIEF SUMMARY OF THE INVENTION

The method aspect of the problem is addressed by a method for the production of a conveying pipe for the transport of solids in claim 1.

An objective aspect of the problem is addressed by a conveying pipe for the transport of solids according to the features in claim 17.

Advantageous embodiment variants of the present invention are described in the dependent claims.

The method according to the invention for the production of a conveying pipe for the conveying of solids, wherein the conveying pipe has a double-walled pipe body with a hardened inner pipe, and with a pipe collar coupled to at least one end, is characterized by the following method steps:
providing a double-walled pipe body with a hardened inner pipe and an outer pipe which encases the same,
optionally heating the end of the outer pipe,
exerting a compressive force on the end face of the outer pipe in such a manner that a longitudinal segment of the outer pipe expands radially outward to create an annular bead at a distance from the end face of the outer pipe, forming a separation gap between the outer pipe and the inner pipe,
placing a pipe collar thereon, and joining the pipe collar thermally to the outer pipe by an external, circumferential, thermal joining seam in the region of the annular bead.

According to the invention, a circumferential annular bead is formed. The annular bead in this case is characterized by an expansion of the outer pipe oriented outward radially. As a consequence, rather than the entire end expanding, according to the invention an axial longitudinal segment at a distance from the free end is expanded. The circumferential annular bead can therefore also be called a fold in the outer pipe. As such, a separation gap is formed between the inner shell surface and/or inner surface of the annular bead and the outer shell surface of the inner pipe, in which there is air. This makes it possible according to the invention to weld the circumferential collar seam without the thermal influence zone which is created in the process negatively affecting the material structure of the hardened inner pipe.

To then apply the annular bead, according to the invention the double-walled pipe body is presented, and the annular bead is formed by exerting a compressive force in the axial direction to the end of the pipe body, particularly the outer pipe.

In the simplest embodiment, this results from a sufficiently high compressive force, optionally with the use of an outer contour tool.

In the preferred embodiment, a predetermined deformation point can also be included in the outer pipe—for example in the form of a groove in the outer pipe running around the periphery thereof. The groove can be designed to run around the outside of the outer shell surface or on the inner shell surface of the outer pipe, or on both surfaces, Because of the predetermined deformation point, when the compressive force is exerted in the axial direction the longitudinal segment, and therefore the formation of the annular bead, are fixed.

However, in a preferred embodiment, the method according to the invention is carried out in such a manner that the end of the pipe body, particularly excluding the longitudinal segment where the annular bead should be formed, is heated in advance. The heating is carried out with a circumferential inductor and/or an inductor coil. The heating offers two advantages.

First, the material structure of the outer pipe can be deformed more easily if heat is applied, In addition, the thermal heating itself produces a radial expansion in the heated region. So that the inner pipe does not undergo any structural change due to this heating, an inner cooling tool is preferably included—for example an internal cooling quench.

After the annular bead is formed, the pipe collar is then coupled and/or pushed-on, and thermally joined to the outer shell surface of the outer pipe with a circumferential joining seam—also called a thermal joining seam. Once the thermal joining seam has cooled down, the region of the annular bead can then deform due to radial contraction. In particular, as a result the inner surface of the annular bead can again come to lie against the outer shell surface of the inner pipe with a positive fit. However, for the actual welding process, the annular bead is expanded radially such that the inner shell surface of the outer pipe and the outer shell surface of the inner pipe are physically uncoupled due to the thermal joining of the thermal joining seam.

The heating is performed at 250° C. to 1500° C., preferably at 750° C. to 1500° C., and particularly preferably at 750° C. to 1000° C., wherein preferably only the axial longitudinal segment is heated to form the annular bead. It is preferred that an outer pipe having a steel alloy is used, with a carbon content of 0.05 to 0.35 wt %. As a result, this is particularly a steel alloy which can be tempered in certain conditions. When heated to one of the temperatures named above, the structure changes particularly into the austenitic structural phase transformation. This then results directly in the expansion directed outward radially. If at this point the thermal joining seam will be subjected to a subsequent process immediately, the same can be carried out after the expansion with no intermediate treatment. However, if the pipe body will be momentarily stored following the expansion, the expanded outer end of the outer pipe can be converted by quenching to an intermediate phase structure and/or a martensitic structural transformation phase, such that the expanded structure is maintained.

The thermal joining seam is then positioned according to the invention, with respect to the axial direction of the pipe body, in such a manner that the separation gap is formed between the inner pipe and the outer pipe radially inward. In particular, the thermal joining seam is created by a welding process—by way of example electron beam welding or MIG/MAG welding, or WIG welding. However, it can also be contemplated that the thermal joining seam is created by soldering. In a welding process in particular, the thermal joining seam can be characterized as a materially-joined seam.

If an outer contour tool is used according to the invention, it is possible to define the longitudinal segment in the axial direction, by the placement of the outer contour tool, in which the annular bead is formed as a result of exerting a compressive force in the axial direction.

The exerting of the compressive force itself can be carried out with a compression tool such that the compression tool is removed after the annular bead is formed. However, the compressive force can be exerted on the outer pipe by the placement of the pipe collar, and therefore via the pipe collar itself. As a consequence, after the annular bead is formed, the pipe collar can remain in position, and the thermal joining can be performed.

In this case, it is not necessary to use an outer contour tool, because the pipe collar particularly takes over the function of the outer contour tool. It is particularly preferred that there is an extension on the pipe collar oriented inward such that when the pipe collar is pressed-on, a compressive force is specifically only transmitted to the end face of the outer pipe.

However, within the scope of the invention, it is also possible for only a part of the pipe collar to be first positioned, wherein the same then assumes the function of an outer contour tool and/or a corresponding spacer tool. After the expansion of the annular bead, the remaining part of the pipe collar can then be positioned on the pipe and thermally joined to the annular bead.

The pipe body itself preferably has a double-walled construction with an outer ring and/or outer collar and an inner ring.

The present invention further relates to a conveying pipe for the transport of solids, having a double-walled pipe body with a pipe collar coupled on the end thereof, wherein the pipe collar is coupled to the outer pipe of the pipe body, circumferentially around the same, with a thermal joining seam. The conveying pipe is characterized according to the invention in that it is expanded, with an annular bead, below the thermal joining seam with respect to a radial direction radially around the circumference thereof, forming a separation gap to the inner pipe. The thermal joining seam is then preferably constructed in the region of the annular bead.

The conveying pipe can particularly be produced according to the invention by means of the method described above. The annular bead and the separation gap which results from the same prevents the heat arising during the creation of the thermal joining seam on the outer shell surface of the outer pipe from acting on the—in particular, tempered—inner pipe. As such, the inner pipe, and particularly the material structure of the tempered inner pipe, cannot be negatively affected by the heat influence zone of the thermal joining seam.

### BRIEF DESCRIPTION OF THE DRAWINGS

Additional advantages, features, properties, and aspects of the present invention are the subject matter of the following description. Preferred embodiment are illustrated in the schematic figures. These serve to facilitate understanding the invention. In the figures:

FIG. 1 shows a production process for a conveying pipe according to the invention,

FIG. 2 shows an enlarged view of a portion of FIG. 1,

FIG. 3 shows the conveying pipe produced according to the invention, upon the completion of the production process, and

FIG. 4 shows an enlarged view of a portion of FIG. 3.

### DETAILED DESCRIPTION OF THE INVENTION

In the figures, for reasons of simplicity, the same reference numbers are used for the same or similar components, even if there is no description provided for the same.

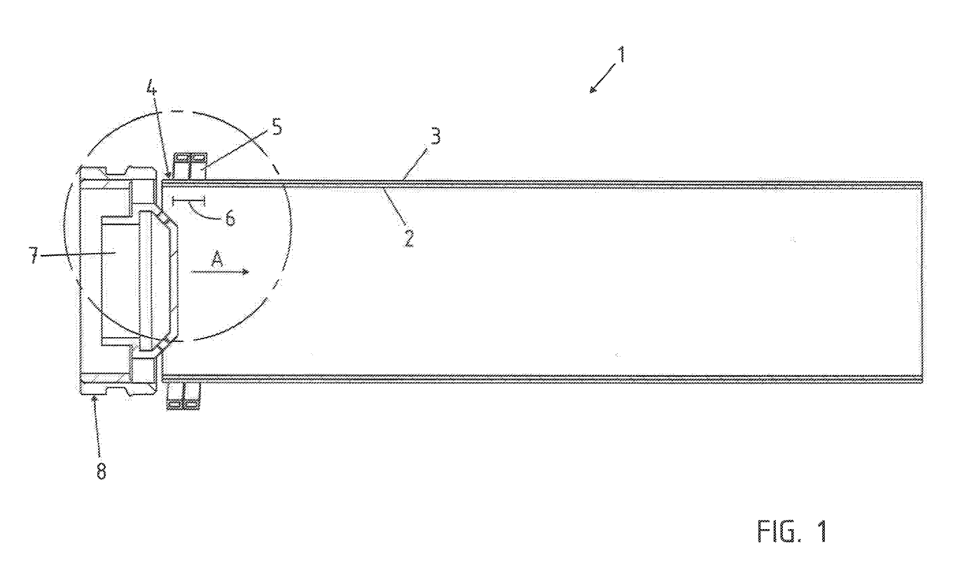

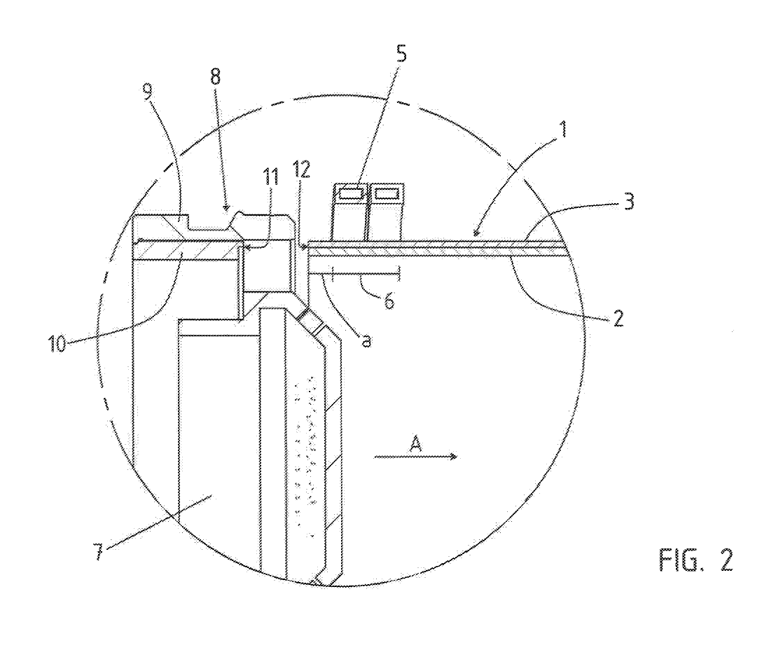

FIG. 1 shows a cutaway view during a process for the production of a conveying pipe 18 according to the invention. A double-walled pipe body 1 is designed for this purpose, having an inner pipe 2 which is particularly tempered, and an outer pipe 3 which surrounds the inner pipe 2. One end 4 of the pipe body 1 is heated by an inductor 5 in the form of an induction coil, and specifically the heating is carried out in a targeted manner in a longitudinal segment 6 defined in the axial direction A. The longitudinal segment 6 is arranged at a distance a from the end face 12, as shown in FIG. 2. In addition, an inner cooling tool 7 is included such that the inner pipe 2 is not heated during the heating of the longitudinal segment 6 and of the outer pipe 3. Subsequently, a double-walled pipe collar 8 is pushed over the end 4 in the axial direction A, wherein the pipe collar 8 has an outer collar 9 and an inner ring 10. The inner ring 10 itself has an extension 11 oriented in the enlarged view in FIG. 2 in the axial direction A, which runs around the circumference and which comes to lie with a positive fit against the end face 12, particularly of the outer pipe 3, when the pipe collar 8 is pushed further. The pipe collar 8 then lies at least partially on the outer shell surface 19 of the outer pipe 3 in such a manner that the outer pipe 3 doesn't expand in this area.

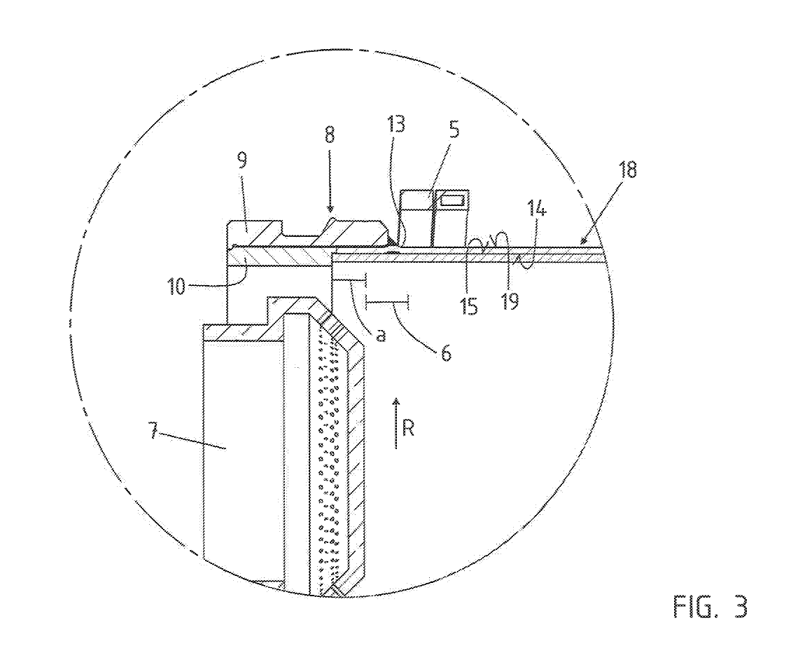

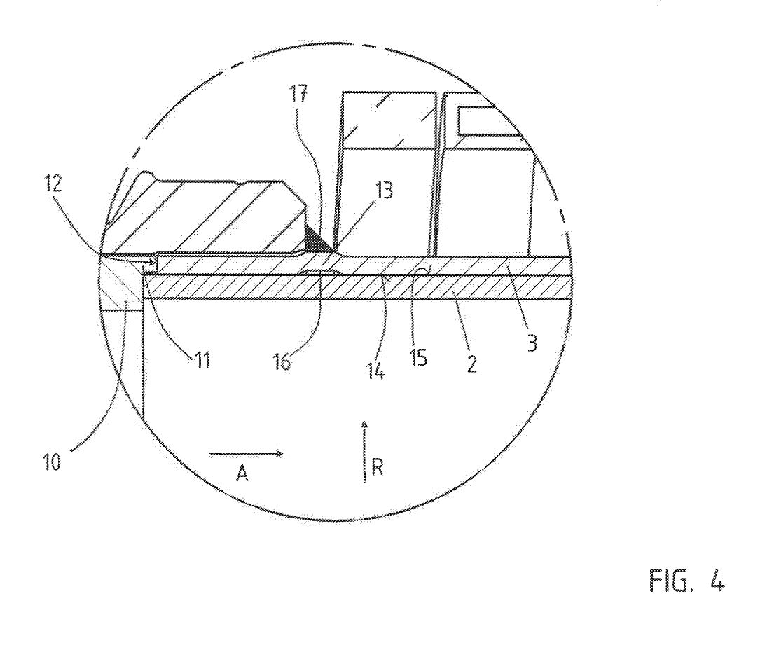

As the pipe collar 8 is further pressed in the axial direction A, a construction as in FIGS. 3 and 4 results. The previously heated longitudinal segment 6 expands on the outer circumference in the radial direction R and forms a circumferential annular bead 13. As such, the inner shell surface 14 of the outer pipe 3 is decoupled from the outer shell surface 15 of the inner pipe 2, forming a separation gap 16 in the region of the annular bead 13. A circumferential thermal joining seam 17, as well as the thermal influence zone thereof which acts on the outer pipe 3, are consequently thermally decoupled from the inner pipe 2 such that no heat is directed into the inner pipe 2 by the outer pipe 3.

The extension 11 of the inner ring 10 in this ease has shifted the end face 12 of the outer pipe 3 in the axial direction A relative to the inner pipe 2 such that the annular bead 13 is created.

The annular bead 13 therefore has a distance a from the free end 4 of the pipe body L As such, after the thermal joining seam 17 is formed, the conveying pipe 18 according to the invention, comprising the pipe body 1 and the pipe collar 8 is finished. As can be seen in FIG. 3, it is also possible that the inductor (5) is shifted in the axial direction (A).

The fact that the circumferential annular bead 13 can contract back in the radial direction R, such that the separation gap 16 is no longer present and the inner surface of the annular bead 13 lies with a positive fit against the outer shell surface 15 of the inner pipe 2, is not illustrated in greater detail.

### List of Reference Numbers:

1—pipe body
2—inner pipe
3—outer pipe
4—end of 1
5—inductor
6—longitudinal segment
7—inner cooling tool
8—pipe collar
9—outer collar of 8
10—inner ring of 8
11—extension of 10
12—end face
13—annular bead
14—inner shell surface of 3
15—outer shell surface of 2
16—separation gap
17—thermal joining seam
18—conveying pipe
19—outer shell surface of 3
A—axial direction
a—distance
R—radial direction

1. A method for the production of a conveying pipe for a thermal joining seam, having a double-walled pipe body with a hardened inner pipe, and with a pipe collar coupled to at least one end, comprising the following method steps:
providing a double-walled pipe body having a hardened inner pipe and an outer pipe which encases the inner pipe;
optionally heating the end of the outer pipe;
exerting a compressive force on the end face of the outer pipe in such a manner that a longitudinal segment of the outer pipe expands radially outward to create an annular bead at a distance from the end face of the outer pipe, forming a separation gap between the cuter pipe and the inner pipe;
placing a pipe collar thereon, and joining the pipe collar thermally to the outer pipe by an external, circumferential, thermal joining seam in the region of the annular bead.

2. The method according to claim 1, wherein the heating is carried out with an inductor, and/or that the end of the outer pipe is heated to 250° C. to 1500° C.

3. The method according to claim 2, wherein the heating is carried out at 750° C. to 1500° C.

4. The method according to claim 2, wherein the heating is carried out at 750° C. to 1000° C.

5. The method according to claim 1, wherein only the longitudinal segment is heated to form the annular bead.

6. The method according to claim 1, wherein an outer pipe is used which has a steel alloy with a carbon content of 0.05 to 0.35 wt %.

7. The method according to claim 1, wherein the thermal joining seam is positioned, with respect to an axial direction of the pipe body, in such a manner that the separation gap is formed between the inner pipe and the outer pipe inwardly in a radial direction.

8. The method according to claim 1, wherein, when the compressive force is applied, an outer contour tool is placed on the outer shell surface of the outer pipe.

9. The method according to claim 1, wherein, when the compressive force is applied, at least one first pipe collar part is placed on the outer shell surface of the outer pipe.

10. The method according to claim 1, wherein, when the compressive force is applied, the pipe collar is placed on the outer shell surface of the outer pipe.

11. The method according to claim 1, wherein the compressive force is applied by a tool and the tool is removed after the molding of the annular bead.

12. The method according to claim 1, wherein the outer tube is quenched after the formation of the annular bead.

13. The method according to claim 1, wherein the pipe collar is placed on the conveying pipe and the compressive force is applied on the outer pipe via the pipe collar.

14. The method according to claim 1, wherein the thermal joining seam contracts upon cooling such that the outer pipe comes to lie with its inner shell surface against the outer shell surface of the inner pipe in the region of the annular bead.

15. The method according to claim 1, wherein a circumferential predetermined deformation point is constructed in the outer pipe in the region in which the annular bead should be formed.

16. The method according to claim 15, wherein the circumferential predetermined deformation point is designed as a circumferential groove.

17. A conveying pipe for the transport of solids, having a double-walled pipe body with a pipe collar coupled on the end thereof, wherein the pipe collar is welded to an outer pipe of the pipe body around the circumference thereof by means of a thermal joining seam, wherein the outer pipe is radially expanded by an annular bead, forming a separation gap toward an inner pipe, below the thermal joining seam with respect to a radial direction.

18. The conveying pipe for the transport of solids wherein it is produced by a method according to claim 1.
